(19) United States
(12) Patent Application Publication
(10) Pub. No.: US 2009/0213877 A1
(43) Pub. Date: Aug. 27, 2009

(54) FIBER LASER

(76) Inventors: Andreas Tunnermann, Weimar (DE); Jens Limpert, Jena (DE); Bulend Ortac, Jena (DE); Thomas Schreiber, Jena (DE); Carsten K. Nielsen, Hammel (DK)

Correspondence Address: BARNES & THORNBURG LLP, 11 SOUTH MERIDIAN, INDIANAPOLIS, IN, 46204, US

(21) Appl. No.: 12/063,917

(22) PCT Filed: Aug. 29, 2006
(86) PCT No.: PCT/EP2006/008521

§ 371 Date: Oct. 16, 2008

(30) Foreign Application Priority Data
Aug. 31, 2005 (DE) 10 2005 042 073.7

(51) Int. Cl. H01S 3/30

(52) U.S. Cl. 372/6

(57) ABSTRACT

A fiber laser for the production of self-similar pulses contains a pumped source and a linear resonator. The linear resonator has two reflectors. The laser further includes a polarization-maintaining fiber doped with an amplifying medium with a normal dispersion β₂>0 in the frequency range prescribed by the amplifying medium and a dispersion-compensating element with an anomalous dispersion β₂<0. The laser further includes an element for decoupling radiation and a non-linear mode coupling element with a modulation depth >0. The fiber, dispersion-compensating element, element for decoupling radiation and non-linear mode coupling element are disposed between the two reflectors in a common beam path delimited by the resonators. The total dispersion of the components disposed in the beam path of the resonator is normal.

The invention relates to a fibre laser with a linear resonator.

Fibre lasers are basically known. They are possible in particular for the generation of ultrashort pulses and hence are suitable for various fields, such as optical communication, optical measurement, laser surgery or material processing.

Industrially the properties of robustness, i.e. long lifespan and stability, compactness, performance and complexity/costs, are essential criteria which make the decision to use such a laser. Correspondingly, development of the fibre laser is driven in this direction.

A fibre laser essentially comprises an optically pumped resonator with a doped fibre as amplifying medium. If the amplification outweighs the optical loss within the resonator, a laser oscillation can be generated.

Normally doping takes place with rare earths, for example erbium or ytterbium.

Various configurations are possible for the construction of the resonator. Linear resonators are known, in which the fibre is disposed between two reflectors.

A fibre laser of this type is disclosed in the publication U.S. Pat. No. 6,570,892 B1.

The fibre laser described there contains an optical resonator which is defined by a first and a second reflector, a pumped light source which generates a pumped light at a specific wavelength or in a specific spectral range, a doped fibre which is disposed within the resonator and is tuned to the pumped light, an optical coupler for coupling the pumped light into the fibre and a saturable absorber which is disposed adjacent to the second reflector and effects an intensity-dependent absorption in the laser wavelength.

The fibres which are used can be in particular fibres which maintain polarisation. As a result, the laser polarisation along a main axis is maintained without further elements being required in order to maintain the polarisation within the laser.

Because of the polarisation-maintaining property of such fibres, the laser light guided to these fibres is very insensitive to external interference. In non-polarisation-maintaining fibres, as a result of external interference, for example acoustic oscillations which change the refractive index of the fibre locally, the laser light or the laser pulse can be permanently disturbed in the propagation thereof and hence the operation of the laser can be destabilised.

Polarisation-maintaining fibres are hence possible in particular if a stable operation of the laser is desired.

The saturable absorber is a non-linear element which passively couples different longitudinal modes. In this way, in particular short laser pulses can be generated at the laser wavelength.

The construction of a fibre laser as described in the publication U.S. Pat. No. 6,570,892 B1 is designed for the generation of solitons. This is revealed in that the dispersion of the fibre in the frequency range which is prescribed by the amplifying medium is anomalous, i.e. β₂ is [ps²/m]<0.

Self-similar pulses cannot however be generated with such a construction.

Self-similar pulses can have a parabolic shape, in contrast to the shape of solitons which is determined by a secant hyperbolic function. Self-similar pulses can be extended or compressed during their propagation but maintain their parabolic shape. In the case of high pulse energies, only parabolic pulses, in contrast to solitons and other pulse forms, can propagate in the resonator without breaking free (“wave breaking free propagation”).

In fibre lasers, solitons have been able to be generated to date up to an energy of approx. 10 pJ. Self-similar pulses relative to solitons and other types of pulse are characterised in that substantially higher pulse energies are possible, in that in particular (because of the parabolic shape) also short pulses with high energies can be generated, especially in the subsequent amplifiers.

It is hence the object of the present invention to produce a fibre laser with a linear resonator which makes it possible to generate self-similar laser pulses in a stable operation.

The invention achieves the object by a fibre laser according to the independent claim.

The invention produces a fibre laser, in particular for the production of self-similar pulses, containing a pumped source and a linear resonator, the linear resonator having two reflectors, a polarisation-maintaining fibre doped with an amplifying medium with a normal dispersion β₂>0 in the frequency range prescribed by the amplifying medium, a dispersion-compensating element with an anomalous dispersion β₂<0, an element for decoupling radiation and a non-linear mode coupling element with a modulation depth >0, fibre, dispersion-compensating element, element for decoupling radiation and non-linear mode coupling element being disposed between the two reflectors in a common beam path delimited by the resonators and the total dispersion of the components disposed in the beam path of the resonator being normal.

The total dispersion of the resonator is normal, i.e. β₂>0, in order to enable for the first time generation of self-similar pulses. This dispersion is determined by the choice of optical components disposed in the beam path.

Furthermore, the polarisation-maintaining fibre has a normal dispersion according to the invention.

Basically, it would be conceivable to use a fibre with an anomalous dispersion and to compensate for this dispersion by further optical components so that the entire system has a normal dispersion. However it has been shown that, with a fibre with an anomalous dispersion, a stable operation of the laser with self-similar pulses is not possible.

In order to be able suitably to adjust the dispersion within the resonator in order to form the desired pulse shape, a dispersion-compensating element is provided. By means of this element, almost independently of the dispersion of the fibre, the dispersion can be set in particular in a range in which the generation of self-similar pulses is possible.

By means of the non-linear mode coupling element with a modulation depth >0, in particular a self-starting operation of the laser is possible.

Because of the separation of mode coupling element from the other components, especially the fibre, polarisation-maintaining fibres in particular can be used in order to achieve amplification and pulse formation. As a result of the fact that polarisation-maintaining fibres are used, a stable operation of the laser is possible even in the case of external interference, which produces changes in the double refraction.

Basically all light sources which generate pumped light in resonance with at least one of the transitions of the doped fibre are suitable as pumped source. For example, LEDs or preferably laser diodes can be used.

By changing the dispersion and/or the power, it is possible also to set other modes of operation, for example a mode in which extended pulses are generated or, in particular due to higher powers in the resonator, the so-called “Bound State” operation in which a plurality of pulses circulates in the resonator at a defined spacing and repetition rate. According to the invention, the generation of self-similar pulses is however preferred.

Instead of polarisation-maintaining fibres, fibres in which only one polarisation is guided in a controlled manner can also be used. In the following, this type of fibres is intended to be included jointly when mentioning polarisation-maintaining fibres as an alternative without reference being made once again expressly to this.

Advantageous developments are described in the dependent claims.

An advantageous development of the invention provides that the total dispersion of the components disposed in the beam path of the resonator of length L is in the range of β₂*L=0.008 ps² to β₂*L=0.1 ps², preferably from β₂*L=0.01 ps² to β²*L=0.05 ps².

In the range of β₂*L=0.008 ps² to β₂*L=0.01 ps², a stable operation of the laser with self-similar pulses is possible, however the stability reducing at the limits of the indicated range. Preferably, the dispersion of the resonator is as a result in the range of β₂*L=0.01 ps² to β²*L=0.05 ps².

It should be noted in this respect that the above dispersion range is a criterion for generation of self-similar pulses in a linear resonator. In general, such a criterion cannot be transferred to other resonator geometries, for example resonators with a ring geometry. This criterion can turn out very differently according to the ring geometry.

An advantageous development of the invention provides that the dispersion-compensating element has an at least negligible Kerr non-linearity.

The Kerr effect is a non-linear effect, the origin of which is a non-linear polarisation produced in a medium, said polarisation changing the propagation of the light. Because of this non-linearity, this effect, if not negligibly small, disturbs the pulse evolution within the resonator, in particular the pulse evolution of self-similar pulses.

An advantageous development of the invention provides that the resonator has an element disposed in the beam path of the resonator for coupling light of the pumped source, the element for coupling preferably being a dichroic mirror, a fibre coupler or a wavelength multiplexer.

An advantageous development of the invention provides that the modulation depth of the non-linear mode coupling element is >1%, preferably >10%.

An advantageous development of the invention provides that the non-linear mode coupling element is a saturable semiconductor mirror.

A saturable semiconductor mirror (SESAM) is a combination of a mirror and a saturable absorber which are manufactured in semiconductor technology. Normally, such a SESAM contains a Bragg mirror and an absorber layer. By variation in the material and design, the parameters of the SESAM, such as for example wavelength, modulation depth and regeneration time, can be adapted to specific applications.

A semiconductor mirror of this type effects a passive mode coupling. An active element for mode coupling is hence unnecessary. Furthermore, the semiconductor mirror replaces one of the two reflectors, as a result of which the construction is reduced by one component.

Alternatively, instead of a SESAM, also a saturable absorber can be used in combination with one of the two reflectors. In this case, the absorber would operate in transmission.

The modulation depth in the context of saturable absorbers is the maximum change of absorption/reflection which is effected by light which impinges on the absorber with a specific wavelength and intensity. The modulation depth hence makes the decision about the process of mode coupling of a pulse which is propagated in the resonator.

The modulation depth for self-starting of the laser is a determining parameter. The modulation depth in this respect is in correlation with the amplification of the resonator. If the amplification in the resonator is low, then a low modulation depth is required in order to enable self-starting of the laser. At high amplifications, a correspondingly higher value can be chosen likewise for the modulation depth.

According to the invention, a modulation depth of >10% is preferred since this is advantageous for a sufficiently rapid pulse formation. However also smaller modulation depths, for example in the range >1%, are basically possible.

An advantageous development of the invention provides that the dispersion-compensating element is a grid compressor, a resonant saturable absorber, a prism compressor and/or a hollow core fibre.

These elements fulfil in particular the prerequisite of having, if at all, at least a negligible Kerr non-linearity.

An advantageous development of the invention provides that the element for decoupling is a wavelength multiplexer, a fibre coupler, a polariser or one of the two reflectors which is configured as a partially reflecting mirror.

An advantageous development of the invention provides that the resonator for the pulse formation has a polarisation-maintaining single mode fibre with a normal dispersion which is disposed in the beam path of the resonator.

Via the length of such a fibre, the pulse rate of the laser can be adjusted in particular to the desired value. For reasons of stability of the laser operation, it is thereby advantageous to use a polarisation-maintaining fibre. According to the invention, all fibres within the resonator are preferably polarisation-maintaining fibres.

An advantageous development of the invention provides that the fibre is a single core fibre or a double core fibre.

Double core fibres are suitable in particular for operation of the laser in which high pulse energies are generated. In such a fibre, the laser light runs within a (polarisation-maintaining) core of the fibre, the pumped light runs essentially in an inner casing which surrounds this core. A further, outer casing around the inner casing with a lower refractive index prevents emergence of the pumped light from the fibre. The pumped light penetrates through the inner core of the fibre upon propagation thereof in the fibre. Laser-active atoms within the core can be excited in this way.

Double core fibres, in comparison to single core fibres, allow coupling of pumped light at a higher power.

For example quartz glass is possible as material for such fibres.

An advantageous development of the invention provides that the amplifying medium is ytterbium (Yb), erbium (Er) or neodymium (Nd) or a mixture of these elements.

Yb, Er or Nd doped quartz glass fibres have a normal dispersion in the frequency range of the laser transitions. These elements are suitable hence for a fibre laser of the described type.

The invention is now described with reference to a plurality of embodiments of a fibre laser according to the invention including Figures.

There are thereby shown

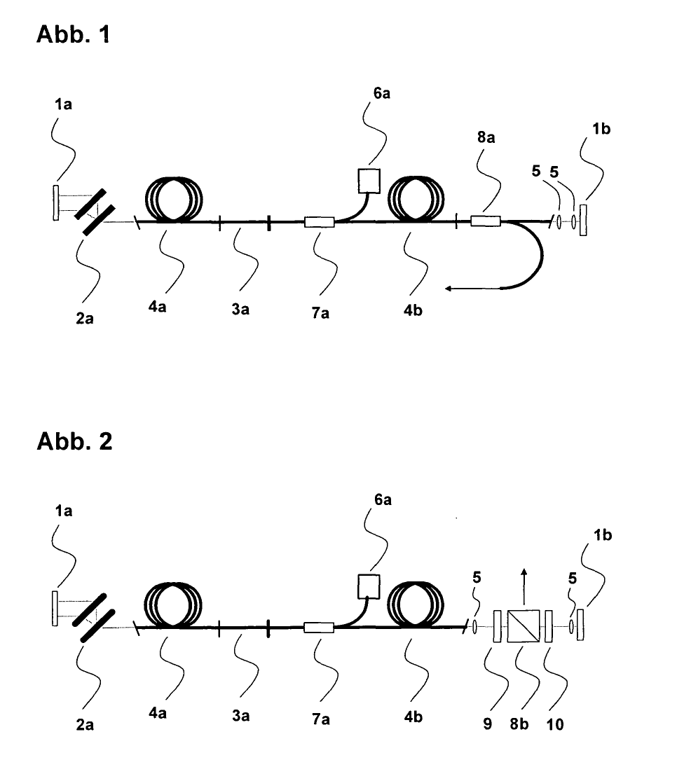

FIG. 1 a first embodiment of a fibre laser according to the invention,

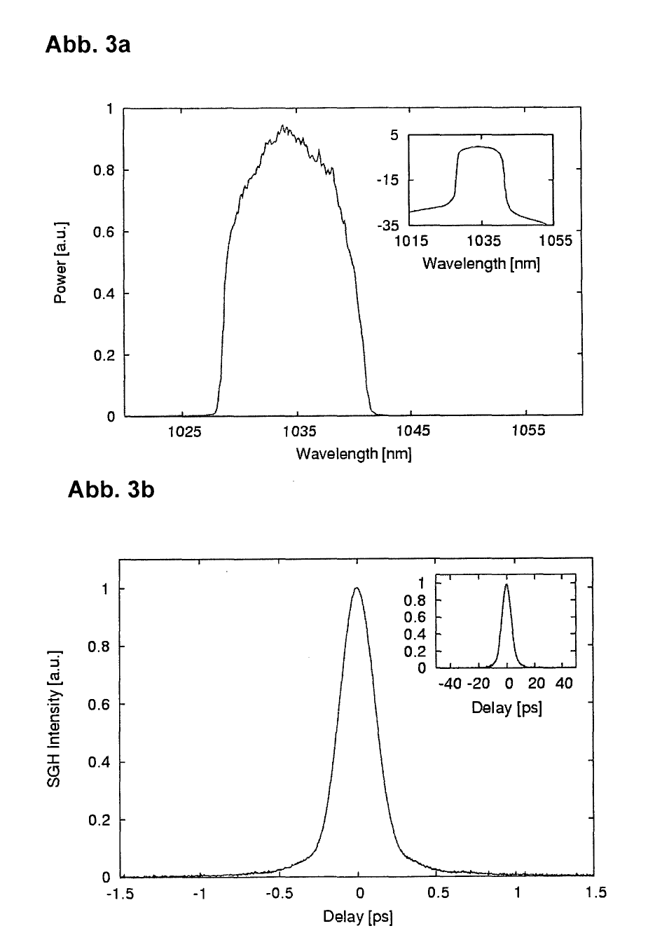

FIG. 2 a second embodiment of a fibre laser according to the invention,

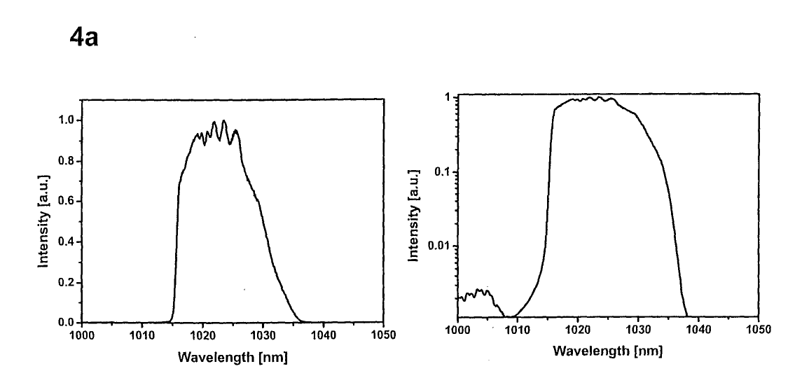

FIG. 3-4 results which were obtained with a fibre laser according to the invention, as described in the first and second embodiment,

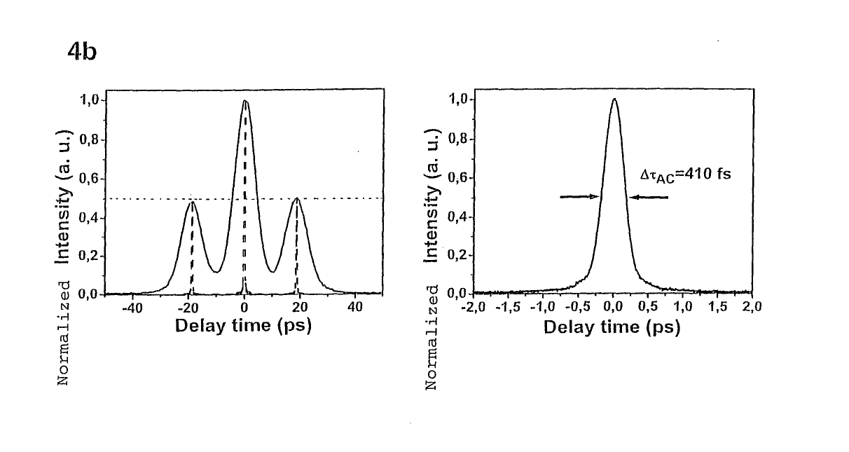

FIG. 5-12 a third to a tenth embodiment of a fibre laser according to the invention.

FIG. 1 shows a first embodiment of a fibre laser according to the invention.

A fibre laser with a pumped source 6 and a linear resonator is represented. The resonator contains two reflectors 2, a polarisation-maintaining fibre 4 doped with an amplifying medium, having a normal dispersion β₂>0, a dispersion-compensating element 2 with an anomalous dispersion, an element for decoupling the radiation 8 and a non-linear mode coupling element.

Furthermore, an element 7 for coupling the radiation of the pumped source is present, and also two polarisation-maintaining single mode fibres 4 with a normal dispersion.

The optical components are disposed in a common beam path defined by the reflectors 1.

The one outer reflector is, in this embodiment, a 100%-reflecting mirror 1a.

A grid compressor 2a is disposed in front of the mirror la as dispersion-compensating element 2. The grid compressor 2a has two grids made of quartz glass at a grid spacing of 1250 lines/mm with a high transmission degree in the first order (>95% of 1020-1080 nm). The grids were disposed at the Lithrow angle (40°) at a spacing of approx. 16 mm.

Thereafter follows a polarisation-maintaining single mode fibre 4a made of quartz glass of the PANDA 980 type with a mode field diameter of 7 μm at a wavelength of 1035 nm and a dispersion of 0.024 ps²/m. In this case, the length of the fibre is 2.60 m in order to convert a specific pulse formation and repetition rate. Basically, this fibre can have also other lengths or diameters according to the purpose of use.

The fibre 4a is not connected directly to the grid compressor, a gap exists between them. In order to enable directed and non-scattered emergence of the light from the fibre, the fibre is polished at a small angle (˜8°).

The fibre 4a is connected to the doped fibre 3 at its other end. The fibre 3 in this case is a 310 mm long, Yb doped polarisation-maintaining fibre 3a made of quartz glass. The absorption of the pumped light of the fibre is approx. 300 dB/m at a wavelength of 976 nm, the mode field diameter is 4.8 μm. In this fibre portion, the light or laser pulse propagating in the resonator is amplified by resonant interaction. The minimum length of the amplifying fibre 3a which is used here makes it possible to decouple filtering of the amplifying spectrum and non-linear development of the laser light within the undoped fibres 4 because the effect of GVD (group velocity dispersion) and non-linearity during the amplification can be neglected.

The element for coupling the pumped light 7 is connected to the other end of the fibre 3a, here a wavelength multiplexer (WDM) 7a. In this case, a single mode diode 6a with a maximum output power of 400 mW at a wavelength of 976 nm was used as pumped source 6.

A further polarisation-maintaining single mode fibre 4 is connected to the WDM 7a. This fibre 4b is of the same type as the fibre 4a, however the length is 2.69 m.

The other end of the fibre 4b is connected to the element for decoupling 8, here a polarisation-maintaining coupler 8a. The decoupling ratio in this special case is 30:70.

The resonator is finally sealed by a second reflector 1, here a saturable mirror (SAM) 1b. An anti-resonant Fabry-Perot saturable semiconductor mirror was used as saturable mirror with a modulation depth of approx. 30%, a saturation threshold of approx. 100 μJ/cm² and a regeneration time in the picosecond range.

In order to achieve the saturation threshold, a telescope which focuses the laser light onto the absorber 1b is produced by means of two lenses 5.

In order to ensure a good optical connection between the individual fibres the fibres were spliced on each other.

In order to ensure that only one polarisation axis is formed, here the slow axis, a λ/2 plate was disposed between grid compressor 2a and fibre 4a.

FIG. 2 shows a second embodiment of a fibre laser according to the invention.

The construction of the second embodiment is similar to the construction of the first embodiment but the fibre coupler 8a is replaced by a polariser 8b as decoupler. A λ/4 plate 9 is disposed on the one side of the polariser, a further λ/2 plate 10 on the other side. It is also possible to dispose polarisation axis and grid of the polariser 8b such that the λ/2 plate 10 can be dispensed with.

FIG. 3 and FIG. 4 show results which were obtained with a fibre laser according to the invention, as described in the first and second embodiment.

FIG. 3a shows an output spectrum of the fibre laser according to the invention in self-similar operating mode. The self-similar pulses are detectable on the parabolic course of the spectrum. The total dispersion of the components in the beam path of the resonator was approx. 0.03 ps².

FIG. 3b shows an autocorrelation of a laser pulse which has been compressed externally to 210 fs (280 fs FWHM).

FIG. 4b shows an output spectrum of the fibre laser according to the invention in stretched-pulse operating mode, i.e. pulses of a non-parabolic shape are generated.

FIG. 4b shows the autocorrelation before and after external compression in the bound-state mode.

The construction of the fibre laser according to the invention is not restricted to the first and second embodiment. FIGS. 5 to 12 show further alternatives in this respect.

FIG. 5 shows a third embodiment of a fibre laser according to the invention.

The fibre laser comprises a pumped source 6 and a linear resonator. The resonator contains two reflectors 1, here a completely reflecting mirror 1a and a saturable semiconductor mirror 1b with a modulation depth >0. A dispersion-compensating element 2 with an anomalous dispersion and a negligible Kerr non-linearity, a polarisation-maintaining single mode fibre 4 with a normal dispersion, a polarisation-maintaining fibre 3 doped with an amplifying medium with a normal dispersion and an element for decoupling radiation or laser light 8 is disposed in the beam path defined by the reflectors 1a and 1b. The doped fibre 3 can be pumped via a pumped source 6. Furthermore, two optical elements, here lenses 5, are disposed in the beam path.

FIG. 6 shows a fourth embodiment of a fibre laser according to the invention.

The fourth embodiment is a concrete representation of the fibre laser described as third embodiment.

The one reflector 1 in this embodiment is a partially reflecting mirror via which power can be decoupled from the resonator. Element 8 for decoupling and reflector 1 are hence represented by one component.

The pumped source 6 is a multimode (MM) diode 6b with a pumped wavelength of 976 nm. The pumped light is coupled via a dichroic mirror 7b in the beam path of the resonator.

The fibre 3 is a polarisation-maintaining double core fibre, which is doped with Yb, with a normal dispersion.

The fibres 3b and 4 are spliced together to form one fibre. The ends of the fibre were polished at a small angle (˜8°).

On both sides of the fibres 3b and 4, respectively one lens 5 for formation of the beam path is disposed.

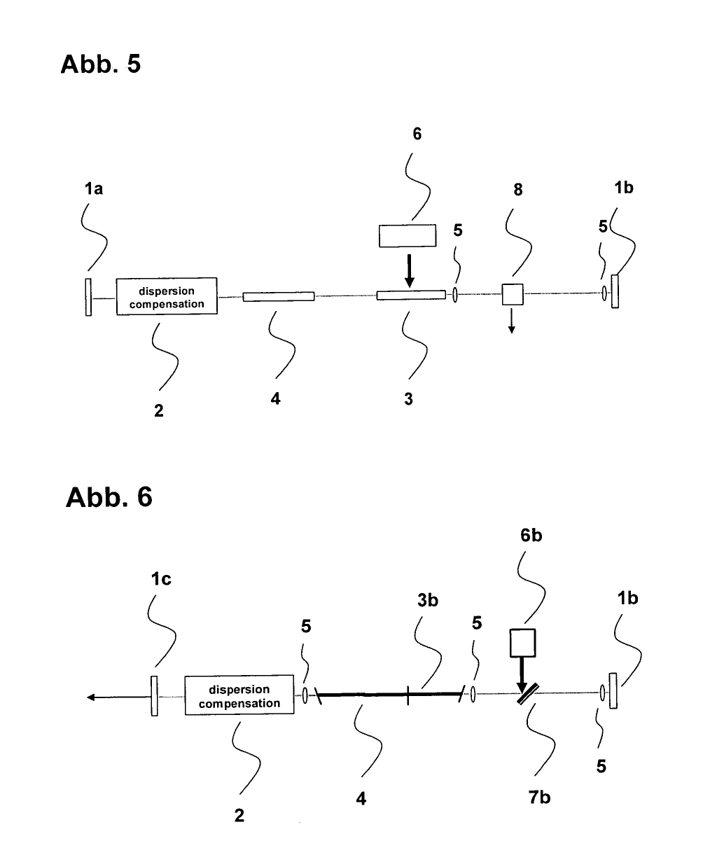

FIG. 7 shows a fifth embodiment of a fibre laser according to the invention.

The fifth embodiment is a modification of the fourth embodiment. Instead of the partially reflecting mirror 1c, a completely reflecting mirror 1a is used. For decoupling laser light, a polariser 8b is disposed in the beam path. A λ/4 plate 9 is disposed on the one side of the polariser, a λ/2 plate 10 on the other side. In this embodiment, a grid compressor is used as dispersion-compensating element, said grid compressor being disposed as the nearest optical element to the mirror 1a.

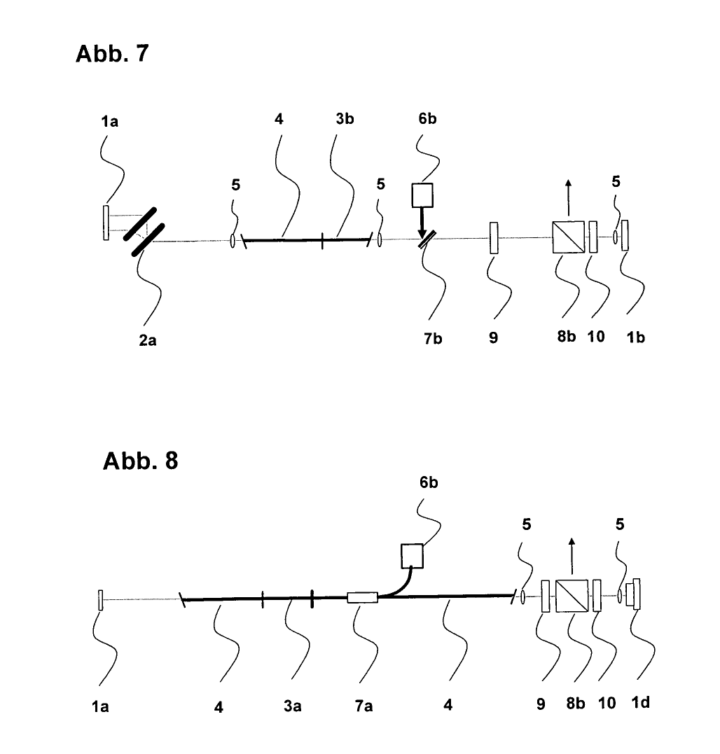

FIG. 8 shows a sixth embodiment of a fibre laser according to the invention.

In contrast to the fifth embodiment, the fibre 3 is a polarisation-maintaining single core fibre 3a, which is doped with Yb, with a normal dispersion. The pumped source 6 is correspondingly a single mode pumped source.

Instead of the dichroic mirror, a polarisation-maintaining WDM 7a is used as element for coupling. The WDM is connected optically on the one hand to the pumped source, on the other hand, to the fibre 3a and to a further single mode fibre 4.

A special saturable resonant semiconductor mirror 1d is used as one of the two reflectors and fulfils, on the one hand, the function of the reflector 1 and, on the other hand, also the function of the non-linear mode coupling element and of the dispersion-compensating element 2.

FIG. 9 shows a seventh embodiment of a fibre laser according to the invention.

In contrast to the sixth embodiment, a grid compressor 2a is used as dispersion-compensating element.

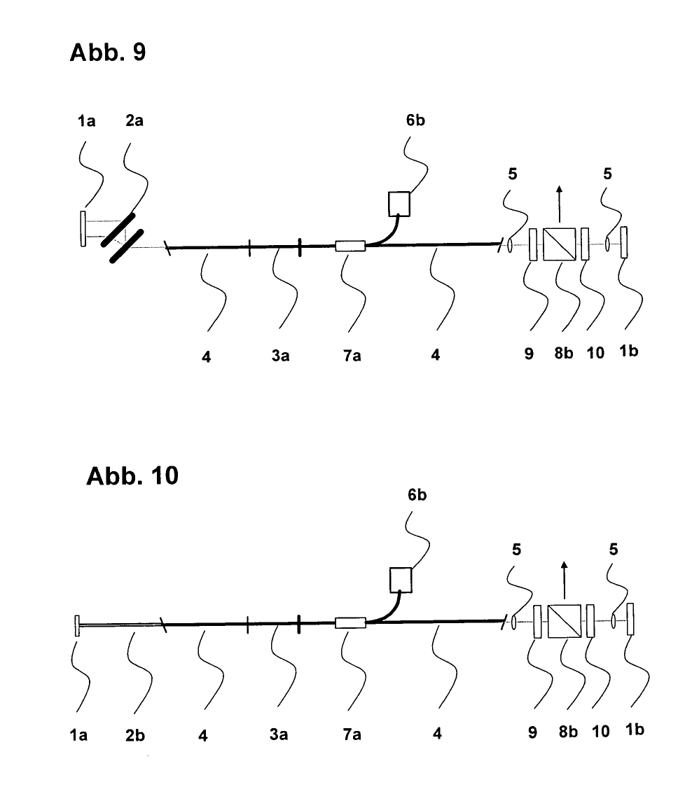

FIG. 10 shows an eighth embodiment of a fibre laser according to the invention.

In contrast to the sixth embodiment, a hollow core fibre 2b is used as dispersion-compensating element.

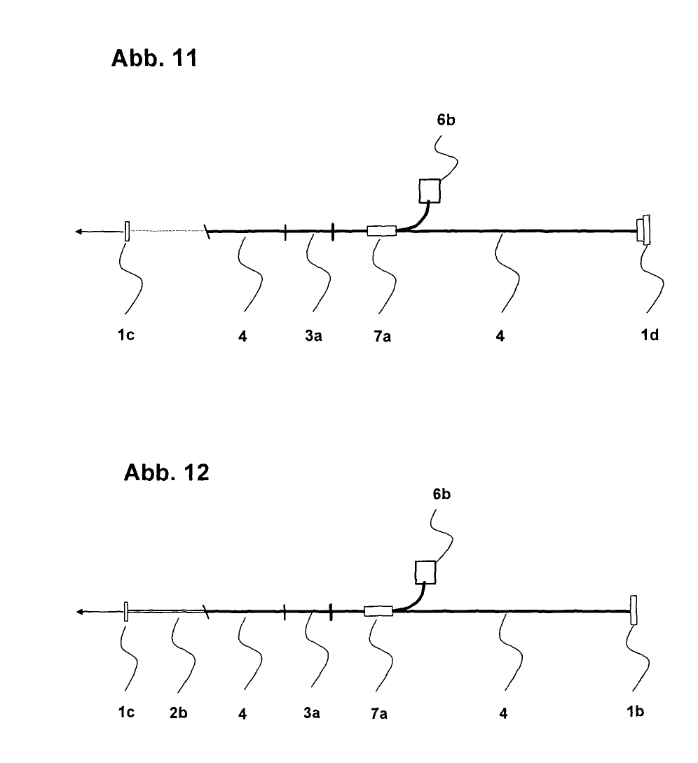

FIG. 11 shows a ninth embodiment of a fibre laser according to the invention.

In contrast to the sixth embodiment (FIG. 8), a partially reflecting mirror 1c as reflector is used as the element for decoupling. The fibre 4 which is disposed between WDM 7a and resonant, dispersion-compensating saturable semiconductor mirror 1d is connected directly to the semiconductor mirror 1d, here by means of an adhesive.

FIG. 12 shows a tenth embodiment of a fibre laser according to the invention.

In contrast to the ninth embodiment, a hollow core fibre 2b is used as dispersion-compensating element. This hollow core fibre 2b is connected to the end of the fibre 4 at one end thereof, by the other end directly to the partially reflecting mirror 1c.

The dispersion-compensating elements which are described in these examples all have an at least negligible Kerr non-linearity. Even prism compressors, which have not yet been mentioned, can be used in this manner. Instead of the fibres 3 which have been doped with Yb, in principle fibres 3 provided with other dopings, in particular with Nd or Er, can be used.

According to the invention, hence a fibre laser with a simple, robust and economical construction can be produced, with which short pulses, in particular self-similar pulses with high energy, can be generated. In the case of self-similar pulses, the pulses emitted by the laser are linearly chirped, so that they can be compressed outwith the resonator in the femtosecond range. The laser according to the invention is thus suitable for a multiplicity of applications in short pulse optics and also in measuring technology. It is especially suitable as a source for high performance amplifier systems since pulse forms can be specially adapted to amplifying profiles and also non-linearity.

1. A fiber laser for the production of self-similar pulses, the fiber laser containing a pumped source and a linear resonator, the linear resonator having two reflectors, a polarization-maintaining fiber doped with an amplifying medium with a normal dispersion β₂>0 in the frequency range prescribed by the amplifying medium, a dispersion-compensating element with an anomalous dispersion β₂<0, an element for decoupling radiation and a non-linear mode coupling element with a modulation depth >0, said fiber, dispersion-compensating element, element for decoupling radiation and non-linear mode coupling element being disposed between the two reflectors in a common beam path delimited by the resonators and the total dispersion of the components disposed in the beam path of the resonators being normal.

2. The fiber laser according to claim 1 wherein the total dispersion of the components disposed in the beam path of the resonator of length L is in the range of β₂*L=0.008 ps² to β₂*L=0.1 ps².

3. The fiber laser according to claim 1 wherein the dispersion-compensating element has an at least negligible Kerr non-linearity.

4. The fiber laser according to claim 1 wherein the resonator has an element disposed in the beam path of the resonator for coupling light of the pumped source, the element for coupling comprising at least one of a dichroic mirror, a fiber coupler and a wavelength multiplexer.

5. The fiber laser according to claim 1 wherein the modulation depth of the non-linear mode coupling element is >1%.

6. The fiber laser according to claim 1 wherein the non-linear mode coupling element comprises a saturable semiconductor mirror.

7. The fiber laser according to claim 1 wherein the dispersion-compensating element comprises at least one of a grid compressor, a resonant saturable absorber, a prism compressor and a hollow core fiber.

8. The fiber laser according to claim 1 wherein the element for decoupling comprises at least one of a wavelength multiplexer, a fiber coupler, a polarizer and one of the two reflectors which is configured as a partially reflecting mirror.

9. The fiber laser according to claim 1 wherein the resonator for pulse formation has a polarization-maintaining single mode fiber with a normal dispersion which is disposed in the beam path of the resonator.

10. The fiber laser according to claim 1 wherein the fiber comprises at least one of a single core fiber and a double core fiber.

11. The fiber laser according to claim 1 wherein the amplifying medium is selected from the group consisting of ytterbium (Yb), erbium (Er), neodymium (Nd) and mixtures of these elements.

12. The fiber laser according to claim 2 wherein the dispersion-compensating element has an at least negligible Kerr non-linearity.

13. The fiber laser according to claim 2 wherein the resonator has an element disposed in the beam path of the resonator for coupling light of the pumped source, the element for coupling comprising at least one of a dichroic mirror, a fiber coupler and a wavelength multiplexer.

14. The fiber laser according to claim 3 wherein the resonator has an element disposed in the beam path of the resonator for coupling light of the pumped source, the element for coupling comprising at least one of a dichroic mirror, a fiber coupler and a wavelength multiplexer.

15. The fiber laser according to claim 12 wherein the resonator has an element disposed in the beam path of the resonator for coupling light of the pumped source, the element for coupling comprising at least one of a dichroic mirror, a fiber coupler and a wavelength multiplexer.

16. The fiber laser according to claim 2 wherein the modulation depth of the non-linear mode coupling element is >1%.

17. The fiber laser according to claim 3 wherein the modulation depth of the non-linear mode coupling element is >1%.

18. The fiber laser according to claim 4 wherein the modulation depth of the non-linear mode coupling element is >1%.

19. The fiber laser according to claim 5 wherein the modulation depth of the non-linear mode coupling element is >1%.

20. The fiber laser according to claim 12 wherein the modulation depth of the non-linear mode coupling element is >1%.
